(19) United States
(12) Patent Application Publication
(10) Pub. No.: US 2009/0000109 A1
(43) Pub. Date: Jan. 1, 2009

(54) Electronic Component Pickup Method, Electronic Component Mounting Method and Electronic Component Mounting Apparatus

(75) Inventors: Mitsuru Ozono, Fukuoka (JP); Hiroshi Haji, Fukuoka (JP); Teruaki Kasai, Fukuoka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/576,362

(22) PCT Filed: Oct. 4, 2005
(86) PCT No.: PCT/JP2005/018333

§ 371 Date: Mar. 30, 2007

(30) Foreign Application Priority Data
Oct. 4, 2004 (JP) 2004-291240

(51) Int. Cl. B23P 19/00

(52) U.S. Cl. 29/740; 29/832; 29/833; 29/834; 29/739; 29/741; 29/721

(57) ABSTRACT

To provide an electronic component pickup method, an electronic component mounting method and an electronic component mounting device capable of stably picking up, with high productivity, an electronic component adhered and held to a carrier.

An electronic component pickup method for picking up a chip 6 adhered and held to a sheet 5 with an adhesive layer 5a by way of a support tool 20 uses an adhesive containing a compound that generates a gas by radiation of light. In the pickup operation, the support tool 20 is brought into contact with the top surface of the chip 6 and a light radiating part 8 is positioned below the chip 6. Then ultraviolet light is radiated from the bottom surface of the sheet 5 onto the adhesive layer 5a positioned on the rear surface of the chip 6. When a nitrogen gas generated from the adhesive layer 5a has formed a gas layer G at the adhesive interface between the rear surface of the chip 6 and the adhesive layer 5a, the support tool 20 is lifted to pick up the chip 6.

### TECHNICAL FIELD

The present invention relates to an electronic component pickup method, an electronic component mounting method and an electronic component mounting device for picking up an electronic component adhered and held to a carrier.

### BACKGROUND ART

A die-bonding device for mounting an individual semiconductor chip segmented from a semiconductor wafer on a substrate such as a lead frame includes a pickup device for peeling off and taking out each semiconductor chip held in the adhered state to a sheet used as a carrier from the sheet.

With this pickup device, as a method for peeling off a semiconductor chip in the adhered state from a sheet, a method using radiation of ultraviolet rays has been in commercial use instead of a related art thrust system using an ejector pin (for example, refer to Patent Reference 1). The ultraviolet radiation method uses an adhesive having a characteristic that adhesion decreases with ultraviolet radiation as an adhesive used to adhere a semiconductor chip on a sheet. This method radiates ultraviolet rays when taking out a semiconductor chip to reduce the adhesion to hold a semiconductor chip to a sheet thus facilitating pickup of a semiconductor chip by way of a sucking collect. Patent Reference 1: JP-A-08-288318

### DISCLOSURE OF THE INVENTION

However, the method disclosed in the patent reference example necessarily includes variations in the adhesion reducing effect by ultraviolet radiation, which makes it difficult to stably performing pickup of a semiconductor chip. In particular, with a low-profile semiconductor chip, it is difficult to efficiently prevent damage such as cracking or chipping caused by pickup operation errors. As a result, it is impossible to stably commercialize the sheet peeling process by ultraviolet radiation with high productivity.

An object of the invention is to provide an electronic component pickup method, an electronic component mounting method and an electronic component mounting device capable of stably picking up, with high productivity, an electronic component adhered and held to a carrier.

The invention provides an electronic component pickup method for picking up from a carrier an electronic component adhered and held to the top surface of a translucent carrier with an adhering substance that generates a gas by radiation of light, the method comprising: an electronic component recognizing step of recognizing the position of an electronic component on the carrier to be picked up; a support tool lowering step of causing a support tool for supporting an electronic component to come into contact with the top surface of the electronic component; a light radiating step of radiating light from the bottom surface of the carrier onto the adhering substance positioned on the rear surface of an electronic component to be picked up to cause the adhering substance to generate a gas; and a support tool lifting step of lifting the support tool, following the light radiating step, to pick up the electronic component.

The invention provides an electronic component mounting method for picking up from a carrier an electronic component adhered and held to the top surface of a translucent carrier with an adhering substance that generates a gas by radiation of light and mounting the electronic component on a substrate, the method comprising: an electronic component position recognizing step of recognizing the position of an electronic component on the carrier to be picked up; an alignment step of horizontally moving the carrier based on the recognition result of the electronic component recognizing step to align the recognized electronic component with a pickup position; a support tool lowering step of causing a support tool for supporting an electronic component to come into contact with the top surface of the electronic component; a light radiating step of radiating light from the bottom surface of the carrier onto the adhering substance positioned on the rear surface of the electronic component to be picked up to cause the adhering substance to generate a gas; a support tool lifting step of lifting the support tool, following the light radiating step, to pick up the electronic component; and an electronic component mounting step of mounting an electronic component supported by the support head on a substrate.

The invention provides an electronic component mounting method for picking up from a carrier an electronic component adhered and held to the top surface of a translucent carrier with an adhering substance that generates a gas by radiation of light and mounting the electronic component on a substrate, the method comprising: an electronic component position recognizing step of recognizing the position of an electronic component on the carrier to be picked up; a support tool lowering step of causing a support tool for supporting an electronic component to come into contact with the top surface of the electronic component; a light radiating step of radiating light from the bottom surface of the carrier onto the adhering substance positioned on the rear surface of an electronic component to be picked up to cause the adhering substance to generate a gas; a support tool lifting step of lifting the support tool, following the light radiating step, to pick up the electronic component; an electronic component alignment step of aligning an electronic component supported by the support head with a substrate based on the recognition result of the electronic component recognizing step; and an electronic component mounting step of mounting the aligned electronic component on the substrate.

The invention provides an electronic component mounting device comprising: a component supply stage for supporting a translucent carrier having a plurality of electronic components adhered and held to the top surface thereof with an adhering substance that generates a gas by radiation of light; a light radiating part for radiating light from the bottom surface of the carrier onto the adhering substance positioned on the rear surface of an electronic component to be picked up to cause the adhering substance to generate a gas; a relative moving mechanism for relatively moving the component supply stage and the light radiating part to align the light radiation range of the light radiating part with the bottom surface of an electronic component to be picked up; a substrate support stage for supporting a substrate where the electronic component is mounted; a component mounting mechanism including a support tool for picking up an electronic component on the carrier and supporting the electronic component, the component mounting mechanism reciprocating between the component supply stage and the substrate support stage and mounting an electronic component on a substrate; an electronic component recognizing part for recognizing the position of an electronic component supported by the support tool; and a control part for controlling the operation of the light radiating part, the relative moving mechanism, the component mounting mechanism and the electronic component recognizing mechanism; characterized in that the control part includes a mounting operation processing part for causing the component recognizing part to perform an electronic component recognizing step of recognizing the position of an electronic component on the carrier to be picked up, causing the relative moving mechanism to perform an alignment step of horizontally moving the carrier based on the recognition result of the electronic component recognizing step to align the recognized electronic component with a pickup position, causing the component mounting mechanism to perform a support tool lowering step of causing a support tool for supporting the electronic component to come into contact with the top surface of the electronic component, causing the light radiating part to perform a light radiating step of radiating light from the bottom surface of the carrier onto the adhering substance positioned on the rear surface of the electronic component to be picked up to cause the adhering substance to generate a gas, causing the component mounting mechanism to perform a support tool lifting step of lifting the support tool, following the light radiating step, to pick up the electronic component, and causing the component mounting mechanism to perform an electronic component mounting step of mounting an electronic component supported by the support head on a substrate.

The invention provides an electronic component mounting device comprising: a component supply stage for supporting a translucent carrier having a plurality of electronic components adhered and held to the top surface thereof with an adhering substance that generates a gas by radiation of light; a light radiating part for radiating light from the bottom surface of the carrier onto the adhering substance positioned on the rear surface of an electronic component to be picked up to cause the adhering substance to generate a gas; a relative moving mechanism for relatively moving the component supply stage and the light radiating part to align the light radiation range of the light radiating part with the bottom surface of an electronic component to be picked up; a substrate support stage for supporting a substrate where the electronic component is mounted; a component mounting mechanism including a support tool for picking up an electronic component on the carrier and supporting the electronic component, the component mounting mechanism reciprocating between the component supply stage and the substrate support stage and mounting an electronic component on a substrate; an electronic component recognizing part for recognizing the position of an electronic component supported by the support tool; and a control part for controlling the operation of the light radiating part, the relative moving mechanism, the component mounting mechanism and the electronic component recognizing mechanism; characterized in that the control part includes a mounting operation processing part for causing the component recognizing part to perform an electronic component recognizing step of recognizing the position of an electronic component on the carrier to be picked up, causing the component mounting mechanism to perform a support tool lowering step of causing a support tool for supporting the electronic component to come into contact with the top surface of the electronic component, causing the light radiating part to perform a light radiating step of radiating light from the bottom surface of the carrier onto the adhering substance positioned on the rear surface of the electronic component to be picked up to cause the adhering substance to generate a gas, causing the component mounting mechanism to perform a support tool lifting step of lifting the support tool, following the light radiating step, to pick up the electronic component, causing the component mounting mechanism to perform an electronic component alignment step of aligning an electronic component supported by the support head with a substrate based on the recognition result of the electronic component recognizing step, and causing the component mounting mechanism to perform an electronic component mounting step of mounting an electronic component supported by the support head on the substrate.

With the invention, it is possible to cause an adhering substance to generate a gas by radiating light from the bottom surface of a carrier onto the adhering substance positioned on the rear surface of an electronic component with a support tool in contact with the top surface of an electronic component to be picked up. It is possible to completely peel off the electronic component from the carrier by lifting the support tool and picking up the electronic component, thereby stably performing the pickup work of an electronic component adhered and held to a carrier with high productivity. On this occasion, the adhering substance is caused to generate a gas with the support tool in contact with the electronic component so that the electronic component will not be moved by the generated gas.

### BRIEF DESCRIPTION OF THE DRAWINGS

FIG. 1 is a side view of an electronic component mounting device according to an embodiment of the invention.

FIG. 2 is a block diagram showing the configuration of the control system of the electronic component mounting device according to an embodiment of the invention.

FIG. 3 is an operation flowchart of an electronic component mounting method according to an embodiment of the invention.

FIG. 4 is an operation flowchart of the electronic component mounting method according to an embodiment of the invention.

FIG. 5 illustrates the operation timing of an electronic component pickup device according to an embodiment of the invention.

FIG. 6 illustrates the operation of an electronic component pickup method according to an embodiment of the invention.

FIG. 7 illustrates the operation of the electronic component pickup method according to an embodiment of the invention.

FIG. 8 illustrates the operation of the electronic component pickup method according to an embodiment of the invention.

FIG. 9 illustrates the operation of the electronic component pickup method according to an embodiment of the invention.

FIG. 10 illustrates the operation of the electronic component pickup method according to an embodiment of the invention.

### BEST MODE FOR CARRYING OUT THE INVENTION

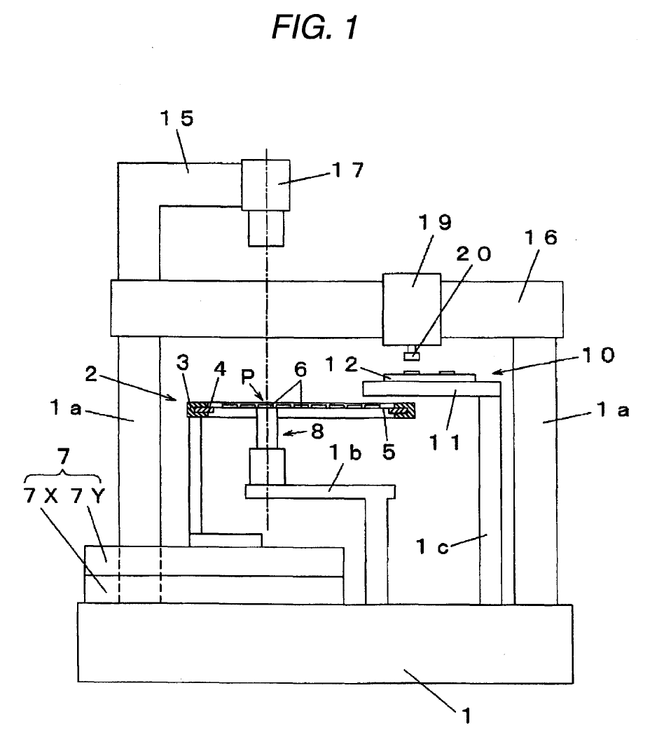

An embodiment of the invention will be described with reference to attached drawings. First, the structure of the electronic component mounting device will be described referring to FIG. 1. In FIG. 1, on a base 1 is arranged movably in horizontal direction a component supply stage 2 by a component supply stage moving mechanism 7 composed of an X-axis table 7X and a y-axis table 7Y. The component supply stage 2 includes a jig holder 3 and the jig holder 3 detachably supports a jig 4 where a sheet 5 is attached. The sheet 5 has a semiconductor chip 6 (hereinafter simply referred to as a “chip 6”) as an electronic component adhered and held thereto in an individually separated piece.

The sheet 5 used as a carrier for the chip 6 is a translucent material such as a transparent resin shaped into a sheet. On the top surface of the sheet 5 is formed an adhesive layer 5a as a thin film of an adhesive (adhering substance) having the following property. An adhesive of a composition containing a compound having a property that generates a gas by radiation of light, for example a compound such as an azido group that is decomposed and generates nitrogen gas by ultraviolet radiation (refer to JP-A-2001-200234).

The sheet 5 is a translucent carrier having a plurality of chips 6 adhered and held thereto with an adhering substance that generates a gas by radiation of light. The component supply stage 2 supports the sheet 5 attached to the jig 4 with the jig holder 3. By using the sheet 5 having the adhesive layer 5a as a carrier for supporting the chips 6 with the adhesive layer 5a, it is possible to facilitate peeling of the chips 6 while the chips 6 are picked up from the sheet 5 as described later.

Below the sheet 5 supported by the jig holder 3 is fixed and held to the base 1 a light radiating part 8 via a support bracket 1b in the inverted-L shape. The light radiating part 8 is arranged at the same horizontal position as a component observation camera 17 described later. This position is a pickup position P where the chip 6 is picked up from the sheet 5 with a support head 20 described later. The light radiating part 8 includes a cylindrical light guide part 8a that comes into contact with the bottom surface of the sheet 5 and a UV light source part 8b (refer to FIG. 9) housed below the light guide part 8a. The light radiating part 8 radiates ultraviolet light projected upward from the UV light source part 8b onto the bottom surface of the sheet 5 via the interior of the light guide part 8a.

As shown in FIG. 9, on the top surface of the light guide part 8a is attached a contact plate 9 having a structure surrounding a translucent body 9a provided in the center with a light shielding body 9b. The ultraviolet light projected from the UV light source part 8b passes through the translucent body 9a and is radiated onto the bottom surface of the sheet 5. The translucent body 9a has a size where the radiation range of ultraviolet light is limited to a single chip 6. By aligning the light radiating part 8 with a chip 6 to be picked up, ultraviolet light is radiated onto the adhesive layer 5a alone positioned on the rear side of the chip.

In the pickup operation where a chip 6 is picked up from a component supply stage 2, a component supply stage moving mechanism 7 is used to horizontally move the sheet 5 to perform alignment operation so that the translucent body 9a will be positioned just below the chip 6 to be picked up. In this state, the UV light source part 8b is turned on and ultraviolet light is radiated onto the bottom surface of the sheet 5 positioned just below the chip 6 to be picked up. This causes the ultraviolet light to pass through the sheet 5 and is radiated onto the adhesive layer 5a, from which a nitrogen gas is generated. The generated nitrogen gas is stagnated at the adhesive interface between the chip 6 and the adhesive layer 5a to form a gas layer G thus dramatically decreasing the support force of the adhesive layer 5a to adhere and hold the chip 6 and facilitating peeling of the chip 6 from the sheet 5.

In the above configuration, the light radiating part 8 radiates ultraviolet light from the bottom surface of the sheet 5 onto the adhesive layer 5a positioned on the rear surface of the chip 6 to be picked up to cause the adhesive layer 5a to generate a nitrogen gas. A component supply stage moving mechanism 7 is a relative moving mechanism that relatively moves the component supply stage 2 and the light radiating part 8 to align the radiation range of the light radiating part 8 with the bottom surface of the chip 6 to be picked up.

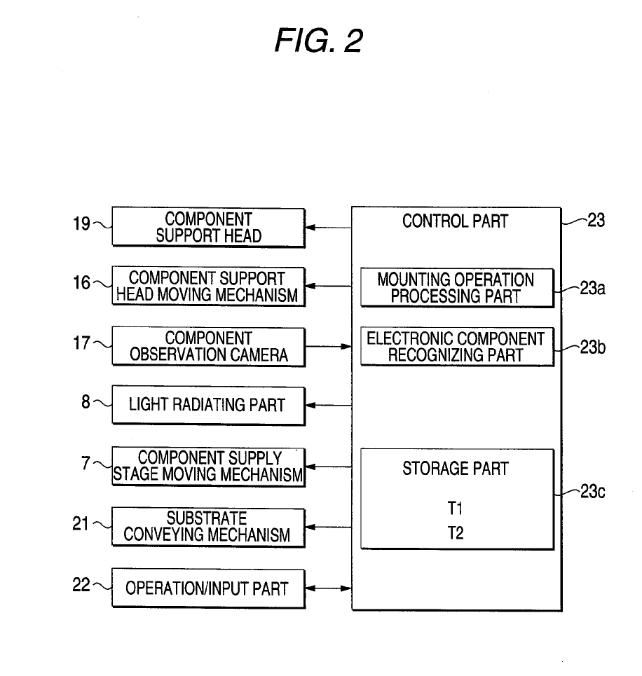

On the base 1 is arranged a substrate support stage 10 adjacently to the component supply stage 2. The substrate support stage 10 includes a support post 1c erected on the base 1 and a substrate support table 11 fixed thereto. The substrate support table 11 supports a substrate 12 where a chip 6 is mounted. The substrate 12 is carried in/out to/from the substrate support table 11 by a substrate conveying mechanism 21 (refer to FIG. 2).

On the support post 1a erected on each end of the top surface of the base 1 is arranged a component support head moving mechanism 16. On the component support head moving mechanism 16 is arranged a component support head 19 movably in horizontal direction. At the bottom of the component support head 19 is attached a support tool 20. The component support head 19 is moved to a pickup position set on the component supply stage 2 and the support tool 20 is lowered. This causes the support tool 20 to hold the chip 6 aligned with the pickup position P by way of vacuum-absorption.

By moving the component support head 16 holding the chip 6 upward above the substrate support table 10 and lifting/lowering the support tool with respect to the substrate 12 supported by the substrate support table 11, the chip 6 supported by the support tool 20 is mounted on the substrate 12. A component head moving mechanism 18 and the component support head 19 form a component moving mechanism including a support tool 20 for picking up a chip 6 on the sheet 5 that reciprocates between the component supply stage 2 and the substrate support stage 10 and mounts the chip 6 on a substrate.

At the top of the support post 1a on the left side is fixed an inverted-L-shaped support bracket 15. To the support bracket 15 is held a component observation camera 17 in the pickup position P for the support tool 20, that is, just above the light radiating part 8. By horizontally moving the component supply stage 2 by way of the component supply stage moving mechanism 7, the chip 6 on the sheet 5 is relatively moved with respect to the component observation camera 17, thereby making it possible to photograph an arbitrary chip 6 supported by the sheet 5 with the component observation camera 17. Through recognition processing of the photographing result with the electronic component recognizing part 23b (refer to FIG. 2) of the control part 23, the position of the chip 6 is recognized.

Next, referring to FIG. 2, the configuration of the control system will be described. The control part 23 includes, as internal mechanisms, a mounting operation processing part 23a, an electronic component recognizing part 23b and a storage part 23c. The control part 23 control the operation and processing of a component mounting mechanism including a component support head 19 and a component support head moving mechanism 16, a light radiating part 8, a component supply stage moving mechanism 7 as a relative moving mechanism, and a substrate carrying mechanism 21. The control part 23 thus controls the operation of the light radiating part, relative moving mechanism, component mounting mechanism and electronic component recognizing part. An operation/Input part 22 is input means such as a keyboard and is used to input an operation command and various data such as time parameters T1 and T2.

The mounting operation processing part 23a controls the component support head 19, component support head moving mechanism 16, light radiating part 8 and component supply stage moving mechanism to perform the mounting operation described later. The electronic component recognizing part 23b recognizes the photographing result by the component observation camera 17 to recognize the position of the chip 6 supported by the sheet 5 on the component supply stage 2.

The storage part 23 stores the time parameters T1, T2. The time parameters T1, T2 are set in order to provide operating conditions for reliably obtaining an effect to facilitate peeling of a chip 6 by the light radiating part 8 in the electronic component mounting operation described later. As shown in FIG. 5, the time parameter T1 indicates a time from the turn-on timing ta to the turn-off timing tb of the UV light source part 8b. By properly setting the time parameter T1, it is possible to eliminate the unnecessary driving time of the UV light source part 8b.

The time parameter T2 indicates a time from the turn-on timing of the UV light source part 8b to a support tool lifting step start timing tc. By properly setting the time parameter T2 on top of the time parameter T1, it is possible to reliably enhance the peeling by way of a nitrogen gas obtained when the chip 6 is supported by the support tool 20 and peeled off from the sheet 5.

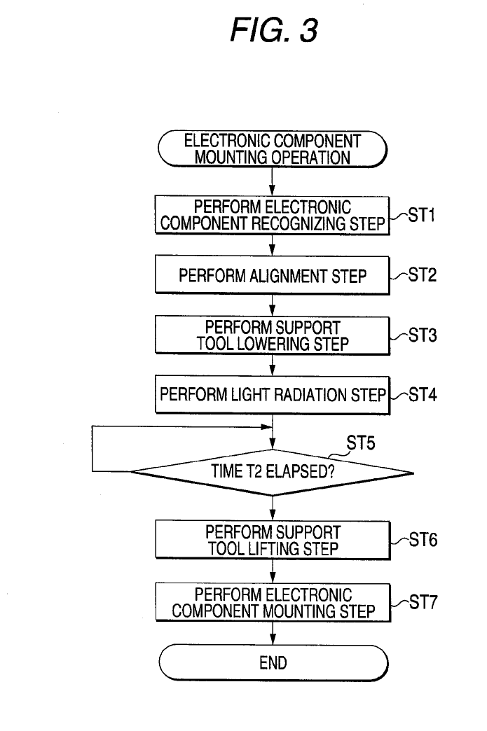

Next, the electronic component mounting operation will be described referring to figures in line with the flowchart of FIG. 3. The electronic component mounting operation constitutes an electronic component mounting method for picking up a chip 6 adhered and held to the top surface of a translucent sheet 5 from the sheet 5 with an adhesive layer 5 that generates a nitrogen gas by ultraviolet radiation.

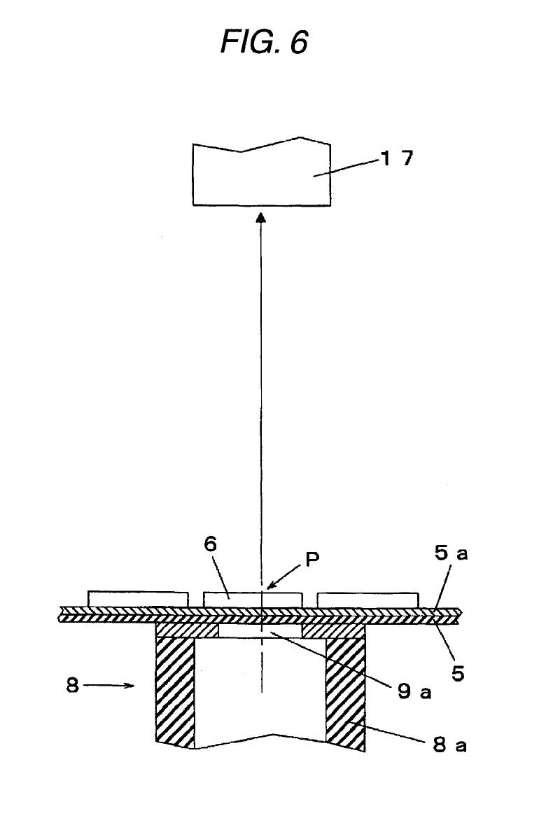

First, an electronic component recognizing step is performed (ST1). As shown in FIG. 6, a chip 6 to be picked up is positioned below a component observation camera 17 and photographed. Then the photographing result is recognized by an electronic component recognizing part 23b to recognize the position of the chip 6. In this state, the chip 6 to be picked up is not correctly aligned with the translucent body 9a of a light radiating part 8, that is, misaligned with the same.

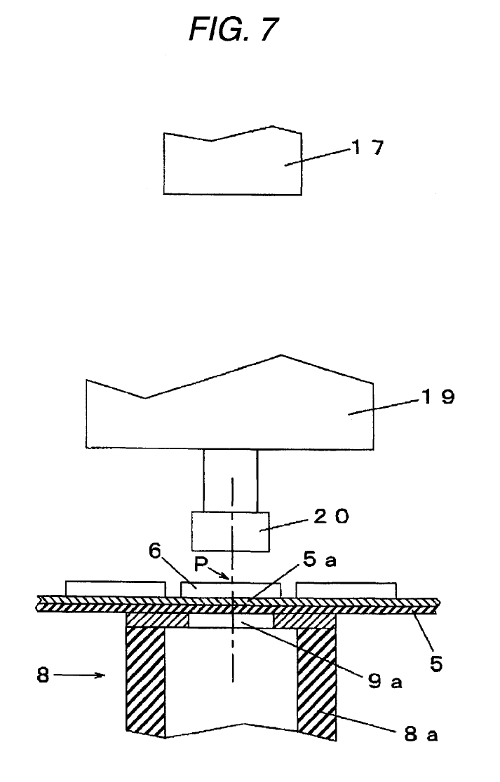

Next, the alignment step is performed (ST2). A component supply stage moving mechanism 7 is driven based on the electronic component recognition result to horizontally move the sheet 5 and correct the misalignment, and thus the chip 6 to be picked up is correctly aligned with the pickup position P for a support tool 20. As a result, as shown in FIG. 7, the chip 6 is also aligned with the light radiating part 8 and the translucent body 9a is positioned just below the chip 6. That is, following the electronic component recognizing step and prior to the support tool lowering step, the sheet 5 is horizontally moved to align the recognized chip 6 with the pickup position P.

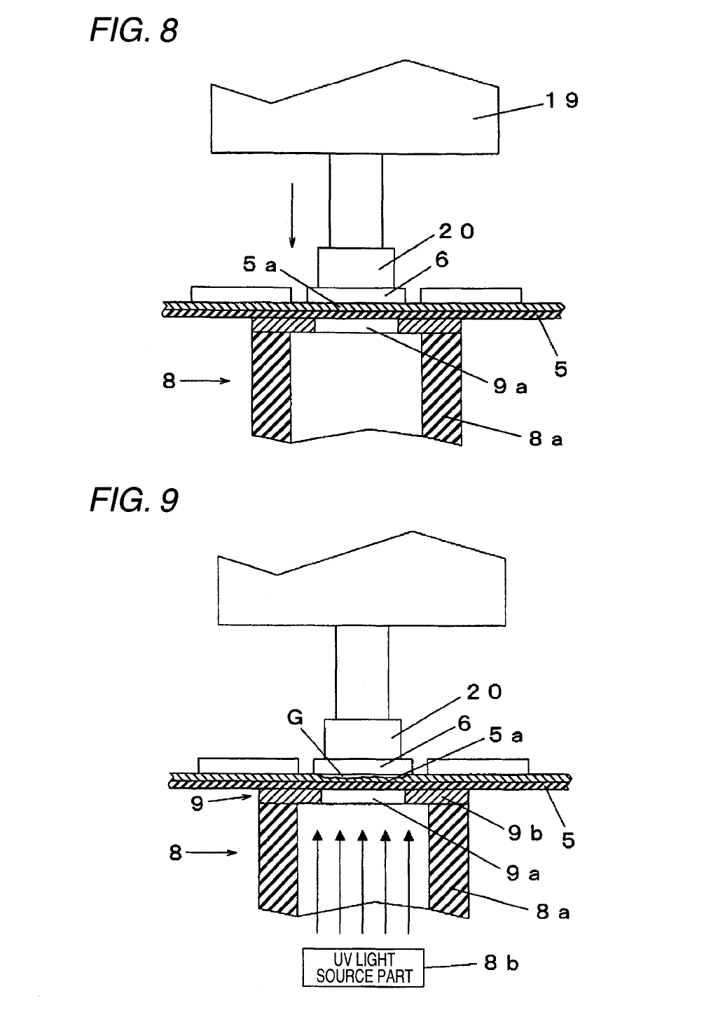

With the chip 6 correctly aligned, the support tool lowing step is performed (ST3). As shown in FIG. 8, the support tool 20 is lowered and caused to come into contact with the top surface of the chip 6. Next, the light radiating step is performed (ST4). As shown in FIG. 9, the UV light source part 8b is turned on and ultraviolet light is radiated from the bottom surface of the sheet 5 onto the adhesive layer 5a positioned on the rear surface of the chip 6 to be picked up to cause the adhesive layer 5a to generate a nitrogen gas. This light radiation is performed for the duration of a predetermined time T2 previously set as a time parameter T2. In the meantime, a component support head 19 is positioned above the chip 6.

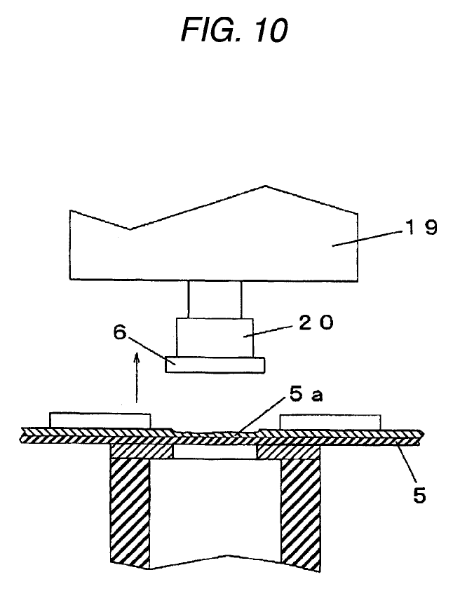

Passage of the time T2 is monitored with a timer (ST5). When the predetermined time T2 has elapsed and a nitrogen gas generated from the adhesive layer 5a is stagnated in a sufficient volume at the adhesive interface between the chip 6 and the adhesive layer 5a to form a gas layer G shown in FIG. 9, the support tool lifting step is performed (ST6). As shown in FIG. 10, the support tool 20 is lifted and the chip 6 supported by the sheet 5 is peeled off from the sheet 5 and picked up. In the support tool lifting step, the support tool 20 is lifted when the predetermined time T2 has elapsed from the light radiation timing in the light radiating step as described earlier. When the chip 6 is picked up by the support tool 20, a component support head 19 moves to a substrate support table 10 and performs the electronic component mounting step (ST9) and mounts the chip 6 on a substrate 12.

As described earlier, the control part 23 includes, as a functional component, the mounting operation processing part 23a for controlling the component support head 19, component support head moving mechanism 18, light radiating part 8 and component supply stage moving mechanism 7. The mounting operation processing part 23a controls these parts to cause them to perform the following operation steps, thus performing the series of electronic component mounting operations described earlier by way of an electronic component mounting device.

That is, an electronic component recognizing part 23b is caused to perform an electronic component recognizing step of recognizing the position of a chip 6 on the sheet to be picked up. A component supply stage moving mechanism 7 is caused to perform an alignment step of horizontally moving the sheet 5 based on the recognition result of the electronic component recognizing step to align the recognized chip 6 with a pickup position. Then, a component support head 19 is caused to perform a support tool lowering step of causing a support tool 20 for supporting a chip 6 to come into contact with the top surface of this chip 6. Next, a light radiating part 8 is caused to perform a light radiating step of radiating light from the bottom surface of the sheet 5 onto a adhesive layer 5a positioned on the rear surface of the chip 6 to be picked up to cause the adhesive layer 5a to generate a nitrogen gas.

Following the light radiating step, a component mounting mechanism composed of a component support head moving mechanism 16 and the component support head 19 is caused to perform a support tool lifting step of lifting the support tool 20 to pick up a chip 6. The component mounting mechanism is then caused to perform an electronic component mounting step of mounting the chip 6 supported by the support tool 20 on a substrate 12.

With this configuration, it is possible to solve problems with a related art electronic component pickup device that radiates ultraviolet light when picking up a semiconductor chip to reduce the adhesion to hold a semiconductor chip on a carrier. With the related art device, it is difficult to stably perform pickup operation due to variations in the adhesion reduction effect by radiation of ultraviolet light. In particular, with a low-profile semiconductor chip, it is difficult to efficiently prevent damage such as cracking or chipping caused by pickup operation errors.

Unlike the related art device, the electronic component pickup device according to this embodiment uses an adhesive that generates a nitrogen gas by ultraviolet radiation to pick up a semiconductor chip while a gas layer of a nitrogen gas is interposed at the interface between the semiconductor chip and a sheet, thereby peeling off the semiconductor chip from the sheet with ease and in a short time.

With this approach, higher-speed pickup operation of a semiconductor chip is ensured without the frequency of occurrence of a fault such as cracking or chipping of a semiconductor chip being increased, thus stably performing the pickup operation of a semiconductor chip adhered and held to a sheet with high productivity. In the foregoing embodiment, the support tool 20 is caused to come into contact with the chip 6 while the chip 6 is aligned with the pickup position P based on the electronic component recognition result. This makes it possible to support the chip 6 in a correct position with the support tool 20 thus ensuring high-accuracy electronic component mounting operation.

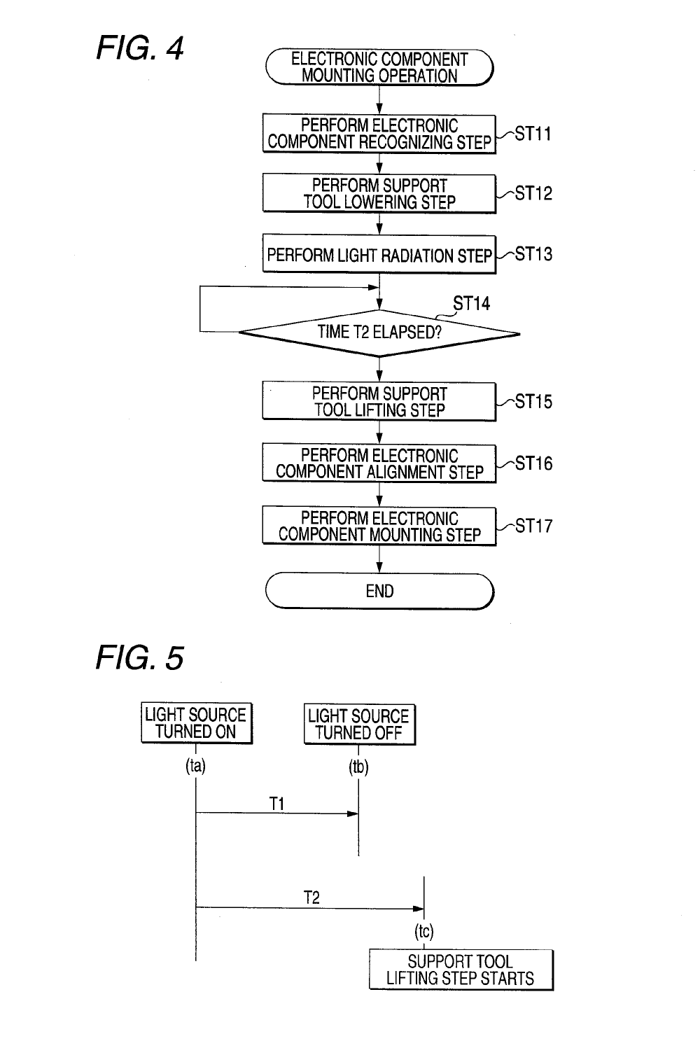

While the alignment step is performed before the support tool lowering step to align the chip 6 on the sheet 5 with the light radiating part 8 permanently arranged just below the pickup position and thus supporting the chip 6 in the correct position of the support tool 20 in the above electronic component mounting operation, the operation sequence shown in the flowchart of FIG. 4 may be employed to skip the alignment step on the component supply stage 2.

(ST11), (ST12), (ST13), (ST14) and (ST15) are operations similar to (ST1), (ST3), (ST4), (ST5) and (ST6) shown in FIG. 3 respectively. In the operation flow shown in FIG. 4, the electronic component alignment step (ST16) is performed following (ST5). That is, based on the recognition result in the electronic component recognizing step performed in (ST11), the chip 6 supported by the support head 20 is aligned with the substrate 12. Then, an electronic component mounting step of mounting the aligned chip 6 on the substrate 12 is performed (ST17).

In the operation flow shown in FIG. 4, the mounting operation processing part 23a causes the pertinent parts to perform the following operations to perform electronic component mounting operation by way of an electronic component mounting device.

An electronic component recognizing part 23b is caused to perform an electronic component recognizing step of recognizing the position of a chip 6 on the sheet 5 to be picked up. Then a component support head 19 is caused to perform a support tool lowering step of causing a support tool 20 for supporting a chip 6 to come into contact with the top surface of this chip 6. Next, a light radiating part 8 is caused to perform a light radiating step of radiating light from the bottom surface of the sheet 5 onto a adhesive layer 5a positioned on the rear surface of the chip 6 to be picked up to cause the adhesive layer 5a to generate a nitrogen gas.

Following the light radiating step, a component support head 19 is caused to perform a support tool lifting step of lifting the support tool 20 to pick up a chip 6. Next, a component mounting mechanism composed of a component support head 19 and a component support head moving mechanism 16 is caused to perform an electronic component alignment step of aligning a chip 6 with a substrate 12 based on the recognition result of the electronic component recognizing step. The component mounting mechanism is then caused to perform an electronic component mounting step of mounting the chip 6 supported by the support tool 20 on a substrate 12. With this configuration also, the same effect as that of the electronic component mounting operation shown in the flowchart of FIG. 3 is obtained.

In this invention, a chip 6 is adhered and held to the adhesive layer 5a composed of an adhesive that generates a gas by radiation of light, so that the timing to cause the support tool to come into contact with the chip 6 is critical. In case the timing to cause the support tool to come into contact with the chip 6 is too late, the chip 6 is moved by a gas generated from the adhesive layer 5a. Thus it is highly possible that the chip 6 is misaligned just before the support tool 6 supports the chip 6.

To solve this problem, the support tool 20 is caused to come into contact with the top surface of the chip 6 to fix the position of the chop 6 before the chip 6 starts to move with a nitrogen gas generated from the adhesive layer 5a in this invention. This prevents possible misaligned mounting caused by displacement of the chip 6 by a nitrogen gas generated from the adhesive layer 5a. The timing to cause the support tool 20 to come into contact with the top surface of the chip 6 may be in a period a nitrogen gas from the adhesive layer 5a is not voluminous even after the radiation of light from the light radiating part 8 although the timing is preferably before radiation of light in order to more reliably prevent movement of the chip 6.

While the invention has been described in detail referring to a specific embodiment, those skilled in the art will recognize that various changes and modifications can be made in it without departing the spirit and scope thereof.

This application is based on the Japanese patent application (Japanese Patent Application No. 2004-291240) and its content is incorporated herein as a reference.

### INDUSTRIAL APPLICABILITY

An electronic component pickup device, an electronic component pickup method and an electronic component mounting device according to the invention has an advantage that it is possible to perform the pickup work of an electronic component adhered and held to a carrier stably and with high productivity and thus useful for an application where an electronic component supported by an adhesive sheet is picked up and mounted on a substrate on a die-bonding device.

1. An electronic component pickup method for picking up from a carrier an electronic component adhered and held to the top surface of a translucent carrier with an adhering substance that generates a gas by radiation of light, said method comprising:
an electronic component recognizing step of recognizing the position of an electronic component on said carrier to be picked up;
a support tool lowering step of causing a support tool for supporting an electronic component to come into contact with the top surface of the electronic component;
a light radiating step of radiating light from the bottom surface of said carrier onto the adhering substance positioned on the rear surface of an electronic component to be picked up to cause the adhering substance to generate a gas; and
a support tool lifting step of lifting said support tool, following said light radiating step, to pick up the electronic component.

2. The electronic component pickup method according to claim 1, characterized in that said support tool is lifted when a predetermined time has elapsed from a light radiation start timing in said light radiating step.

3. The electronic component pickup method according to claim 1, characterized in that an alignment step of aligning an electronic component recognized by horizontally moving said carrier with a pickup position following said electronic component recognizing step and prior to said support tool lowering step.

4. The electronic component pickup method according to claim 1, characterized in that said light radiating step is performed while said support tool is in contact with the top surface of said electronic component in said support tool lowering step.

5. An electronic component mounting method for picking up from a carrier an electronic component adhered and held to the top surface of a translucent carrier with an adhering substance that generates a gas by radiation of light and mounting the electronic component on a substrate, said method comprising:
an electronic component position recognizing step of recognizing the position of an electronic component on said carrier to be picked up;
an alignment step of horizontally moving said carrier based on the recognition result of said electronic component recognizing step to align said recognized electronic component with a pickup position;
a support tool lowering step of causing a support tool for supporting an electronic component to come into contact with the top surface of the electronic component;
a light radiating step of radiating light from the bottom surface of said carrier onto the adhering substance positioned on the rear surface of the electronic component to be picked up to cause the adhering substance to generate a gas;
a support tool lifting step of lifting said support tool, following said light radiating step, to pick up said electronic component; and
an electronic component mounting step of mounting an electronic component supported by said support head on a substrate.

6. The electronic component mounting method according to claim 5, characterized in that said support tool is lifted when a predetermined time has elapsed from a light radiation start timing in said light radiating step.

7. The electronic component mounting method according to claim 5, characterized in that said light radiating step is performed while said support tool is in contact with the top surface of said electronic component in said support tool lowering step.

8. An electronic component mounting method for picking up from a carrier an electronic component adhered and held to the top surface of a translucent carrier with an adhering substance that generates a gas by radiation of light and mounting the electronic component on a substrate, said method comprising:
an electronic component position recognizing step of recognizing the position of an electronic component on said carrier to be picked up;
a support tool lowering step of causing a support tool for supporting an electronic component to come into contact with the top surface of the electronic component;
a light radiating step of radiating light from the bottom surface of said carrier onto the adhering substance positioned on the rear surface of an electronic component to be picked up to cause the adhering substance to generate a gas;
a support tool lifting step of lifting said support tool, following said light radiating step, to pick up said electronic component, an electronic component alignment step of aligning an electronic component supported by said support head with a substrate based on the recognition result of said electronic component recognizing step; and
an electronic component mounting step of mounting the aligned electronic component on said substrate.

9. The electronic component mounting method according to claim 8, characterized in that said support tool is lifted when a predetermined time has elapsed from a light radiation start timing in said light radiating step.

10. The electronic component mounting method according to claim 8, characterized in that said light radiating step is performed while said support tool is in contact with the top surface of said electronic component in said support tool lowering step.

11. An electronic component mounting device comprising:
a component supply stage for supporting a translucent carrier having a plurality of electronic components adhered and held to the top surface thereof with an adhering substance that generates a gas by radiation of light;
a light radiating part for radiating light from the bottom surface of said carrier onto the adhering substance positioned on the rear surface of an electronic component to be picked up to cause the adhering substance to generate a gas;
a relative moving mechanism for relatively moving said component supply stage and said light radiating part to align the light radiation range of said light radiating part with the bottom surface of an electronic component to be picked up;
a substrate support stage for supporting a substrate where said electronic component is mounted;
a component mounting mechanism including a support tool for picking up an electronic component on said carrier and supporting the electronic component, said component mounting mechanism reciprocating between said component supply stage and said substrate support stage and mounting an electronic component on a substrate;
an electronic component recognizing part for recognizing the position of an electronic component supported by said support tool; and
a control part for controlling the operation of said light radiating part, said relative moving mechanism, said component mounting mechanism and said electronic component recognizing mechanism;
wherein said control part includes a mounting operation processing part for causing said component recognizing part to perform an electronic component recognizing step of recognizing the position of an electronic component on said carrier to be picked up,
causing said relative moving mechanism to perform an alignment step of horizontally moving said carrier based on the recognition result of said electronic component recognizing step to align said recognized electronic component with a pickup position,
causing said component mounting mechanism to perform a support tool lowering step of causing a support tool for supporting said electronic component to come into contact with the top surface of the electronic component,
causing said light radiating part to perform a light radiating step of radiating light from the bottom surface of said carrier onto the adhering substance positioned on the rear surface of said electronic component to be picked up to cause the adhering substance to generate a gas,
causing said component mounting mechanism to perform a support tool lifting step of lifting said support tool, following said light radiating step, to pick up said electronic component, and
causing said component mounting mechanism to perform an electronic component mounting step of mounting an electronic component supported by said support head on a substrate.

12. An electronic component mounting device comprising:
a component supply stage for supporting a translucent carrier having a plurality of electronic components adhered and held to the top surface thereof with an adhering substance that generates a gas by radiation of light;
a light radiating part for radiating light from the bottom surface of said carrier onto the adhering substance positioned on the rear surface of an electronic component to be picked up to cause the adhering substance to generate a gas;
a relative moving mechanism for relatively moving said component supply stage and said light radiating part to align the light radiation range of said light radiating part with the bottom surface of an electronic component to be picked up;
a substrate support stage for supporting a substrate where said electronic component is mounted;
a component mounting mechanism including a support tool for picking up an electronic component on said carrier and supporting the electronic component, said component mounting mechanism reciprocating between said component supply stage and said substrate support stage and mounting an electronic component on a substrate;
an electronic component recognizing part for recognizing the position of an electronic component supported by said support tool; and
a control part for controlling the operation of said light radiating part, said relative moving mechanism, said component mounting mechanism and said electronic component recognizing mechanism;
wherein said control part includes a mounting operation processing part for causing said component recognizing part to perform an electronic component recognizing step of recognizing the position of an electronic component on said carrier to be picked up,
causing said component mounting mechanism to perform a support tool lowering step of causing a support tool for supporting said electronic component to come into contact with the top surface of the electronic component,
causing said light radiating part to perform a light radiating step of radiating light from the bottom surface of said carrier onto the adhering substance positioned on the rear surface of said electronic component to be picked up to cause the adhering substance to generate a gas,
causing said component mounting mechanism to perform a support tool lifting step of lifting said support tool, following said light radiating step, to pick up said electronic component,
causing said component mounting mechanism to perform an electronic component alignment step of aligning an electronic component supported by said support head with a substrate based on the recognition result of said electronic component recognizing step, and
causing said component mounting mechanism to perform an electronic component mounting step of mounting an electronic component supported by said support head on said substrate.
